(19) United States
(12) Patent Application Publication
(10) Pub. No.: US 2025/0386290 A1
(43) Pub. Date: Dec. 18, 2025

(54) NON-TERRESTRIAL NETWORK UTILIZATION DURING LOW ACTIVITY AT TERRESTRIAL BASE STATIONS

(71) Applicant: T-MOBILE INNOVATIONS LLC, Overland Park, KS (US)

(72) Inventor: Gaviphat LEKUTAI, Kirkland, WA (US)

(21) Appl. No.: 18/744,252

(22) Filed: Jun. 14, 2024

(51) Int. Cl. H04W 52/02; H04W 76/19; H04W 84/06

(52) U.S. Cl. CPC H04W 52/0206; H04W 76/19; H04W 84/06

(57) ABSTRACT

Systems and methods for saving energy at a base station are provided. A low activity period of the base station may be determined based on historical traffic parameters and/or a utilization of the base station falling below a pre-determined threshold. The base station ceases transmissions at a beginning of the low activity period. One or more UEs may connect to one or more nodes of a non-terrestrial radio access network (RAN). The base station resumes transmissions at an end of the low activity period.

### SUMMARY

The present disclosure is directed to systems and methods of saving energy within a network, substantially as shown and/or described in connection with at least one of the Figures, and as set forth more completely in the claims.

According to various aspects of the technology, systems and methods to save energy at a base station are provided. A low activity period of a base station within a terrestrial network may be proactively determined and/or reactively determined. In some aspects, the low activity period of the base station may be prospectively predicted based on one or more historical traffic parameters. In other aspects, the low activity period may be reactively determined based on a utilization of the base station and/or a utilization of one or more nodes of a non-terrestrial network. At a beginning of the low activity period, the base station ceases transmissions. One or more UEs may connect and communicate with to the one or more nodes of the non-terrestrial network prior to or during the low activity period of the base station. At an end of the low activity period, the base station resumes transmissions. By ceasing transmissions at times of low activity at the base station, costs associated with expenditure of unnecessary resources during the low activity period may be reduced.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates an exemplary computing device for use with the present disclosure;

FIG. 2 illustrates a diagram of an exemplary environment in which implementations of the present disclosure may be employed;

FIG. 3 depicts a flow diagram of an exemplary prospective method for saving energy within a network, in accordance with embodiments described herein;

FIG. 4 depicts a flow diagram of an exemplary reactive method for saving energy within a network, in accordance with embodiments described herein; and

FIG. 5 depicts a flow diagram of an exemplary hybrid method for saving energy within a network, in accordance with embodiments described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “network access technology (NAT)” is synonymous with wireless communication protocol and is an umbrella term used to refer to the particular technological standard/protocol that governs the communication between a user equipment (UE) and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, the provision of telecommunication services is moving beyond the surface of the earth at increasing speed. Network operators, once exclusively operating terrestrial base stations, will begin to utilize non-terrestrial network systems (e.g., drones, satellites) to provide services to subscribers. Existing terrestrial base stations frequently experience times of low or no activity, such as late at night or early in the morning. During these times of low or no activity, the base station consumes a substantial amount of valuable resources to service a small number of active connections. The allocation of significant resources for a small number of serviced subscribers yields minimal benefits, as this practice is not cost-effective nor an efficient use of resources. Systems and methods to avoid the expenditure of these valuable resources at times of low or no activity at terrestrial base stations, such as with the assistance of non-terrestrial networks, may increase both cost and energy savings.

Conventionally, when a particular base station is predicted to enter or is experiencing a period of low or no activity, the base station may be deactivated and existing connections to the base station may be diverted to other nearby base stations, if possible. For example, when a 5G base station is predicted to have low activity, the 5G base station may handover existing connections to one or more nearby base stations and the 5G base station may be deactivated to save resources. However, conventional base station energy saving mechanisms do not allow for the most efficient use of resources. For example, nearby base stations receiving connections from the low activity base station may reach a utilization capacity preventing the nearby base stations from receiving additional connections from the low activity base station. In this example, the number of low activity base stations that can be deactivated is limited by the utilization capacity of the nearby base stations. In other examples, there may not be a base station near enough to accept traffic from the low activity base station, leaving UEs in the coverage area of the deactivated, low activity base station without service. Systems and/or methods to improve the use of network resources at times of low activity would reduce costs and increase the efficient use of resources.

In order to improve the efficient use of resources, and in contrast to conventional solutions, the present disclosure is directed to shutting down or ceasing transmissions by a terrestrial base station at times of low or no activity, requiring any existing connections to the terrestrial base station to connect to one or more nodes of a non-terrestrial network. Any UEs subsequently entering the low activity terrestrial base station's coverage area may be served by the one or more nodes of the non-terrestrial network. By providing a non-terrestrial network to accept traffic that would have connected to the low activity terrestrial base station, more base stations may be deactivated in times of low and no activity, providing an improved use of resources in the network environment.

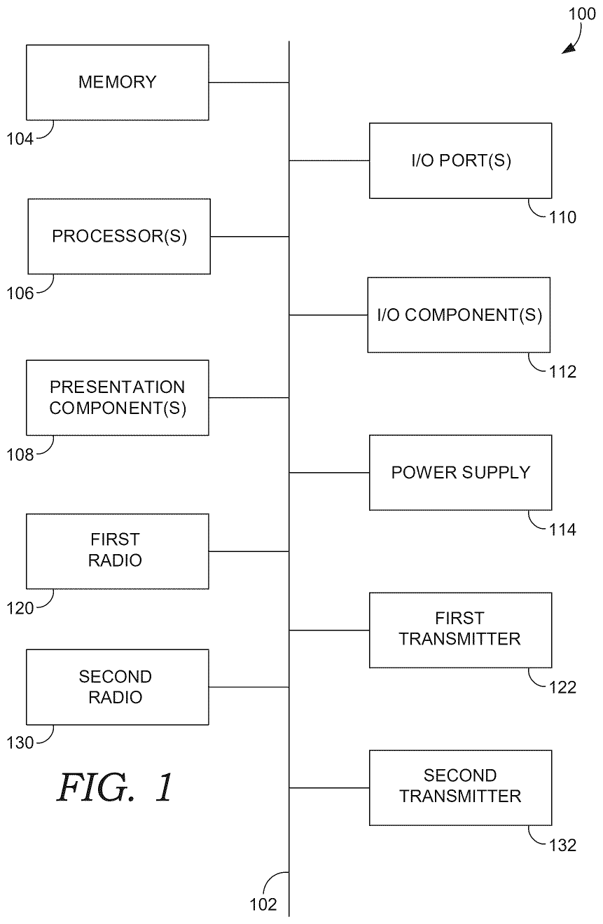

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device. The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of the I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer-storage media and communication media. Computer-storage media includes both volatile and nonvolatile, removable and non-removable media implemented in any method or technology for storage of information such as computer-readable instructions, data structures, program modules or other data. Computer-storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer-storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, 6G, NR, VoLTE, or other VoIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may be configured to communicate with one or more other computing devices according to a local area communication protocol (e.g., IEEE 802.11 series, Bluetooth, NFC, z-wave, or the like).

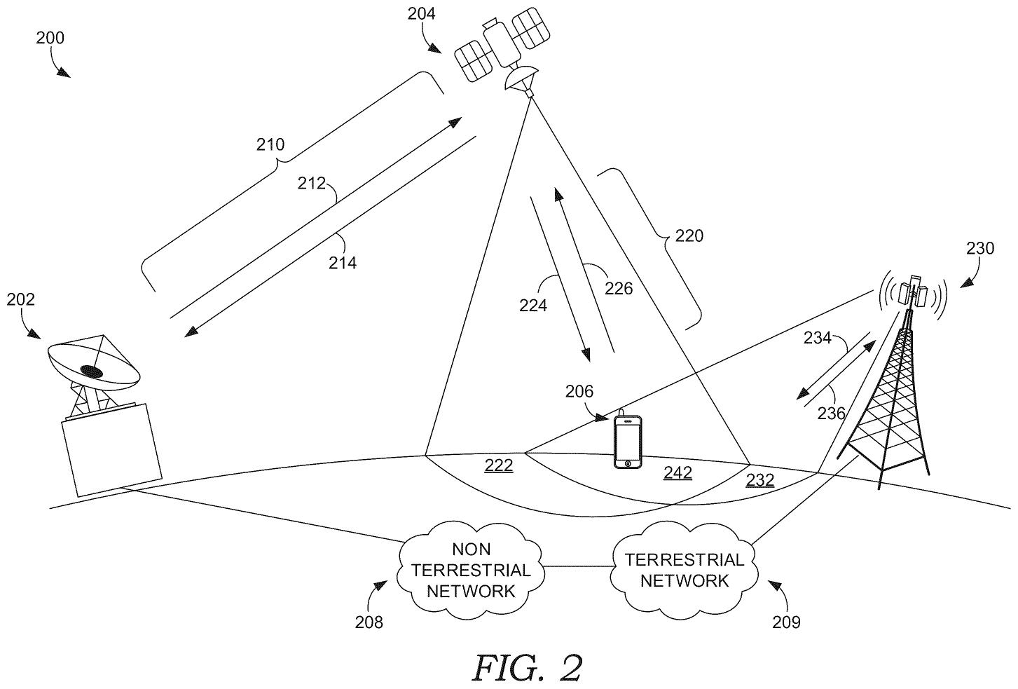

Turning now to FIG. 2, an exemplary network environment is illustrated in which implementations of the present disclosure may be employed. Such a network environment is illustrated and designated generally as network environment 200. At a high level the network environment 200 comprises a gateway 202, a non-terrestrial node 204 of a non-terrestrial radio access network (RAN) 208 (i.e., non-terrestrial network 208), one or more UEs (e.g., a UE 206), and a terrestrial base station 230 of a terrestrial RAN 209 (i.e., terrestrial network 209). Though the composition of network environment 200 illustrates some objects in the singular, it should be understood that more than one of each component is expressly conceived as being within the bounds of the present disclosure; for example, the network environment 200 may comprise multiple UEs, multiple gateways, multiple non-terrestrial nodes that communicate with a single gateway, multiple terrestrial base stations, and the like.

The network environment 200 includes one or more UEs, such as the UE 206. In aspects, the UE 206 is a non-terrestrial network compatible UE. Though the UE 206 is illustrated as a cellular phone, a UE suitable for implementations with the present disclosure may be any computing device having any one or more aspects described with respect to FIG. 1. Although the network environment 200 shows a single UE (i.e., the UE 206), it is expressly contemplated that the network environment 200 may include a plurality of UEs.

The network environment 200 includes a gateway 202 communicatively connected to the non-terrestrial network 208 and the non-terrestrial node 204. The gateway 202 may be connected to the non-terrestrial network 208 via one or more wireless or wired connections and is connected to the non-terrestrial node 204 via a feeder link 210. The gateway 202 may take the form of a device or a system of components configured to communicate with the UE 206 via the non-terrestrial node 204 and to provide an interface between the non-terrestrial network 208 and the non-terrestrial node 204. Generally, the gateway 202 utilizes one or more antennas to transmit signals to the non-terrestrial node 204 via a forward uplink 212 and to receive signals from the non-terrestrial node 204 via a return downlink 214. The gateway 202 may communicate with a plurality of non-terrestrial nodes, including the non-terrestrial node 204.

The network environment 200 includes one or more non-terrestrial nodes, represented by non-terrestrial node 204. The non-terrestrial node 204 may take various forms (e.g., satellites, drones, aircrafts, high altitude platforms, and the like). The non-terrestrial node 204 is generally configured to relay communications between the gateway 202 and one or more UEs, such as the UE 206. The non-terrestrial node 204 communicates with the gateway 202 using the feeder link 210 and communicates with the UE 206 using a user link 220. The user link 220 comprises a forward downlink 224 used to communicate signals from the non-terrestrial node 204 to the UE 206 and a return uplink 226 used to communicate signals from the UE 206 to the non-terrestrial node 204. The non-terrestrial node 204 may communicate with the UE 206 using any wireless telecommunication protocol desired by a network operator, including but not limited to 3G, 4G, 5G, 6G, 802.11x and the like. Though shown as having a single beam providing coverage to a non-terrestrial coverage area 222, the non-terrestrial node 204 may be configured to utilize a plurality of individual beams to communicate with multiple different areas at or near the same time. Similarly, though a single forward downlink 224 and a single return uplink 226 are illustrated, the UE 206 may utilize multiple downlinks and/or multiple uplinks to communicate with the non-terrestrial node 204, using any one or more frequencies as desired by a network operator.

In some aspects, the non-terrestrial node 204 is a satellite having an orbit around the Earth. The orbit of any particular satellite will vary by operator desire and/or intended use. For example, a satellite suitable for use with the present disclosure may be characterized by its maximum orbital altitude and/or orbital period as Low Earth Orbit (LEO), Medium Earth Orbit (MEO), and High Earth Orbit (HEO). In such aspects, the orbit of the non-terrestrial node 204 may proceed such that the UE 206 is no longer within the non-terrestrial coverage area 222, but the UE 206 may now be within a coverage area of another non-terrestrial node of the non-terrestrial network 208. In such aspects, the UE 206 may be handed over from the non-terrestrial node 204 to the other non-terrestrial node to preserve the connection to the non-terrestrial network 208.

The network environment 200 includes one or more non-terrestrial networks, represented by the non-terrestrial network 208. The non-terrestrial network 208 comprises any one or more public or private networks. The non-terrestrial network 208 may be configured according to one or more network architectures and/or principles, such as conventional RAN, cloud-based RAN, and/or open RAN technologies. In some aspects, the non-terrestrial network 208 may be configured as a satellite network connecting to a plurality of gateways, such as the gateway 202. A UE, such as the UE 206, may communicate with the non-terrestrial network 208 via one or more non-terrestrial nodes, such as the non-terrestrial node 204. In aspects, the non-terrestrial network 208 utilizes a first frequency range to communicate with one or more UEs (e.g., the UE 206).

The network environment 200 includes one or more terrestrial base stations, represented by terrestrial base station 230. The terrestrial base station 230 is generally configured to relay communications between the terrestrial network 209 and one or more UEs, such as the UE 206. The terrestrial base station 230 communicates signals to the UE 206 using a terrestrial downlink 234 and receives signals from the UE 206 using a terrestrial uplink 236. The terrestrial base station 230 may communicate with the UE 206 using any wireless telecommunication protocol desired by a network operator, including but not limited to 3G, 4G, 5G, 6G, 802.11x and the like. Though shown as having a single beam providing coverage to a terrestrial coverage area 232, the terrestrial base station 230 may be configured to utilize a plurality of individual beams to communicate with multiple different areas at or near the same time. Similarly, though a single terrestrial downlink 234 and a single terrestrial uplink 236 are illustrated, the UE 206 may utilize multiple downlinks and/or multiple uplinks to communicate with the terrestrial base station 230, using any one or more frequencies as desired by a mobile network operator.

The network environment 200 includes one or more terrestrial networks, represented by the terrestrial network 209. The terrestrial network 209 comprises any one or more public or private networks. The terrestrial network 209 may be configured according to one or more network architectures and/or principles, such as conventional RAN, cloud-based RAN, and/or open RAN technologies. In some aspects, the terrestrial network 209 may comprise a cellular telecommunications network (e.g., a 4G, 5G, or 6G core network, an IMS network, and the like), a data network, and/or a publicly switched telephony network (PSTN). A UE, such as the UE 206, may communicate with the terrestrial network 209 via one or more terrestrial base stations, such as the terrestrial base station 230. In aspects, the terrestrial network 209 utilizes a second frequency range to communicate with one or more UEs (e.g., the UE 206). In such aspects, the first frequency range of the non-terrestrial network 208 and the second frequency range of the terrestrial network 209 are different.

In aspects of the present disclosure, there may exist an overlapping coverage area 242, wherein the non-terrestrial coverage area 222 and the terrestrial coverage area 232 at least partially overlap. The non-terrestrial coverage area 222 and the terrestrial coverage area 232 may be determined to at least partially overlap where an edge of the non-terrestrial coverage area 222 is within a predetermined threshold distance of an edge of the terrestrial coverage area 232. One or more UEs, such as the UE 206, may be located within the overlapping coverage area 242, such that the one or more UEs may connect to the terrestrial base station 230 and/or the non-terrestrial node 204. In some aspects, the overlapping coverage area 242 may include the entire terrestrial coverage area 232.

The terrestrial base station 230 may occasionally, frequently, and/or cyclically experience low levels of network activity during various times of the day or week, such as late night hours or early morning hours when most subscribers are asleep. Conventionally, when such a terrestrial base station experiences a low activity period, the base station may be deactivated, enter a low usage mode, and/or cease all transmissions to UEs. In these conventional solutions, connections may be handed over to nearby base stations to service the few subscribers with active connections during the low activity periods. However, these solutions are limited by the utilization capacity of nearby base stations, limiting the amount of base stations that can cease transmissions, deactivate, and/or enter a low-power mode. Relevant to the present disclosure, connections needing service following transmissions ceasing by a low activity base station may connect to the one or more non-terrestrial nodes (e.g., the non-terrestrial node 204).

The present disclosure contemplates various types of embodiments. In some aspects, proactive, predictive embodiments are contemplated, wherein a low activity period of the terrestrial base station 230 is predicted based on one or more historical traffic parameters. In other aspects, reactive, descriptive embodiments are contemplated, wherein the low activity period of the terrestrial base station 230 is determined based on a utilization of the terrestrial base station 230 falling below a pre-determined threshold. In additional aspects, hybrid embodiments incorporating one or more aspects of each of the proactive and reactive embodiments are contemplated. The embodiments described herein are provided for illustrative purposes only, and the scope of the present disclosure is not limited to the specific implementations presented.

In proactive embodiments, one or more historical traffic parameters of the terrestrial base station 230 may be used to predict a low activity period of the terrestrial base station 230. Traffic parameters of the terrestrial base station 230 that may comprise the one or more historical traffic parameters may include a number of active connections, resource block utilization, throughput, bandwidth, memory usage, idle periods, and the like. The historical traffic parameters may be generated by monitoring traffic parameters over a time period. For example, the number of active connections to the terrestrial base station 230 may be monitored over one or more daily periods, weekly periods, monthly periods, yearly periods, or a combination of these. By monitoring traffic parameters for a time period, historical traffic parameters may be generated. For example, the historical traffic parameter may be based on a predicted number (or percentage) of allocated/used resource blocks compared to a total available number of resource blocks or a predicted amount of allocated/used spectrum compared to a total available spectrum.

The one or more historical traffic parameters may assist in determining a first time associated with a beginning of a predicted low activity period of the terrestrial base station 230. For example, the historical traffic parameter may be a number of active connections to the terrestrial base station 230 during a daily period (e.g., the number of active connections to the terrestrial base station 230 during a twenty-four hour period), and monitored over weeks, months, and/or year to generate historical traffic trends. These historical traffic trends allow one or more network components to determine the first time associated with the beginning of the low activity period of the terrestrial base station 230. In this example, the first time may be one or more times of day, as determined by the historical number of active connections during the daily period, associated with a predicted number of active connections falling below a pre-determined active connection threshold. In another example, the historical traffic parameter may be a predicted resource block utilization of the base station, and the first time may be associated with one or more times of day associated with a predicted resource block utilization falling below a pre-determined resource block utilization threshold.

One or more computer processing components may cause the one or more UEs, such as the UE 206, to connect to one or more nodes of the non-terrestrial network 208, such as the non-terrestrial node 204. In aspects, this may include the terrestrial base station 230 handing over its connections to the non-terrestrial node 204 prior to the first time. The UE 206 may be instructed to connect to the non-terrestrial node 204 by receiving a radio control channel (RRC) connection message requesting the UE alter or switch its spectrum from that of the terrestrial network 209 to that of the non-terrestrial network 208. In other aspects, this may include the terrestrial base station 230 ceasing transmissions to the one or more UEs at the first time and subsequently causing the one or more UEs to engage in cell search and selection to identify and connect to one or more nodes of the non-terrestrial network 208 during the low activity period.

In aspects, the terrestrial base station 230 may cease transmissions at the first time determined based on one or more historical traffic parameters. The terrestrial base station 230 may cease transmissions when the terrestrial base station 230 receives a command from one or more network components to cease signal transmissions (and deactivate radios used to receive signals from one or more UEs), when a network operator manually switches the terrestrial base station 230 to a deactivated state, when the terrestrial base station 230 no longer receives power from a power supply, and the like. The terrestrial base station 230 may cease transmissions when the terrestrial base station 230 enters a low-power mode. In aspects, the terrestrial base station 230 may be scheduled to cease transmissions at the first time. By the terrestrial base station 230 ceasing transmissions, the energy and resources required to operate the terrestrial base station 230 may be reduced during the low activity period, increasing the efficient use of network resources. As used herein, ceasing transmissions may take the form of the terrestrial base station 230 entering into an idle or dormant mode wherein downlink signals are not transmitted to one or more UEs and radio equipment used to receive uplink signals from the one or more UEs is powered off or deactivated.

The one or more historical traffic parameters may assist in determining a second time associated with an end of the predicted low activity period of the terrestrial base station 230. For example, the historical traffic parameter may be a number of active connections to the terrestrial base station 230 during a daily period (e.g., the number of active connections to the terrestrial base station 230 during a twenty-four hour period), allowing the one or more network components to determine the second time associated with the end of the low activity period of the terrestrial base station 230. In this example, the second time may be one or more times of day, as determined by the historical number of active connections during the daily period, associated with a predicted number of active connections exceeding a pre-determined active connection threshold. In other examples, the historical traffic parameter may be a resource block utilization of the terrestrial base station 230 or other traffic parameters described herein.

The terrestrial base station 230 may resume transmissions to one or more UEs, such as the UE 206, at the second time. The terrestrial base station 230 may resume transmissions when it receives a software command from one or more network components to resume transmissions, when a network operator manually switches the terrestrial base station 230 to an activated state, when the terrestrial base station 230 resumes receiving power from a power supply, and the like. The terrestrial base station 230 may resume transmissions when the terrestrial base station 230 exits a low-power mode. In aspects, the terrestrial base station 230 may be scheduled to resume transmissions at the second time.

In reactive embodiments, the low activity period of the terrestrial base station 230 may be determined using one or more utilizations of the terrestrial base station 230. The utilization of the terrestrial base station 230 may be based on current, actual usage of radio frequency resources at the terrestrial base station 230. In aspects, the utilization of the terrestrial base station 230 may be based on a number of active connections to the terrestrial base station 230. The utilization of the terrestrial base station 230 may also be based on a number (or percentage) of allocated/used resource blocks compared to a total available number of resource blocks or an amount of allocated/used spectrum compared to a total available spectrum. The utilization of the terrestrial base station 230 may be associated with a measure of throughput, bandwidth, memory usage, idle periods, and the like. The utilization of the terrestrial base station 230 may fall below a pre-determined threshold and trigger a beginning of the low activity period at the terrestrial base station 230. For example, when the number of active connections to the terrestrial base station 230 fall below a pre-determined active connection threshold, the beginning of the low activity period of the terrestrial base station 230 occurs. Prior to or during the low activity period, one or more computer processing components may cause one or more UEs to connect to one or more nodes of the non-terrestrial network 208, as described elsewhere herein. At the beginning of the low activity period, the terrestrial base station 230 may cease transmissions to the one or more UEs, such as the UE 206, as described elsewhere herein.

In aspects, a utilization of the non-terrestrial node 204 may exceed a pre-determined threshold and trigger an end of the low activity period at the terrestrial base station 230. The utilization of the non-terrestrial node 204 may be based on actual usage of radio frequency resources at the non-terrestrial node 204. In aspects, the utilization of the non-terrestrial node 204 may be based on a number of active connections to the non-terrestrial node 204. The utilization of the non-terrestrial node 204 may also be based on a number (or percentage) of allocated/used resource blocks compared to a total available number of resource blocks or an amount of allocated/used spectrum compared to a total available spectrum. The utilization of the non-terrestrial node 204 may be associated with a measure of throughput, bandwidth, and/or memory usage of the non-terrestrial node 204. The utilization of the non-terrestrial node 204 may exceed a pre-determined threshold and trigger the end of the low activity period at the terrestrial base station 230. For example, when the number of active connections to the non-terrestrial node 204 exceeds a pre-determined active connection threshold, the end of the low activity period of the terrestrial base station 230 occurs. In aspects, when the end of the low activity period occurs, the terrestrial base station 230 may resume transmissions to UEs, such as the UE 206, as described elsewhere herein.

In hybrid embodiments, the beginning of the low activity period of the terrestrial base station 230 may be predicted using one or more historical traffic parameters, as described elsewhere herein. In such hybrid embodiments, the one or more historical traffic parameters may assist in determining the first time associated with the beginning of the predicted low activity period of the terrestrial base station 230, as described elsewhere herein. One or more computer processing components may cause the one or more UEs, such as the UE 206, to connect to the one or more nodes of the non-terrestrial network 208, such as the non-terrestrial node 204, as described elsewhere herein. At the first time, the terrestrial base station 230 may cease transmissions to one or more UEs, such as the UE 206, as described elsewhere herein.

In some hybrid embodiments, the terrestrial base station 230 may resume transmissions to UEs, such as the UE 206, at a second time. In such embodiments, the second time is associated with the earliest of the end of the predicted low activity period of the terrestrial base station 230 or a time associated with the utilization of the one or more nodes of the non-terrestrial node 204 exceeding a pre-determined threshold, as described elsewhere herein. As used herein, “earliest of” refers to the possibility occurring first in time. In other hybrid embodiments, the terrestrial base station 230 may resume transmissions to UEs, such as the UE 206, when the utilization of the one or more nodes of the non-terrestrial network 208, such as the network node 204, exceeds the pre-determined threshold, as described elsewhere herein.

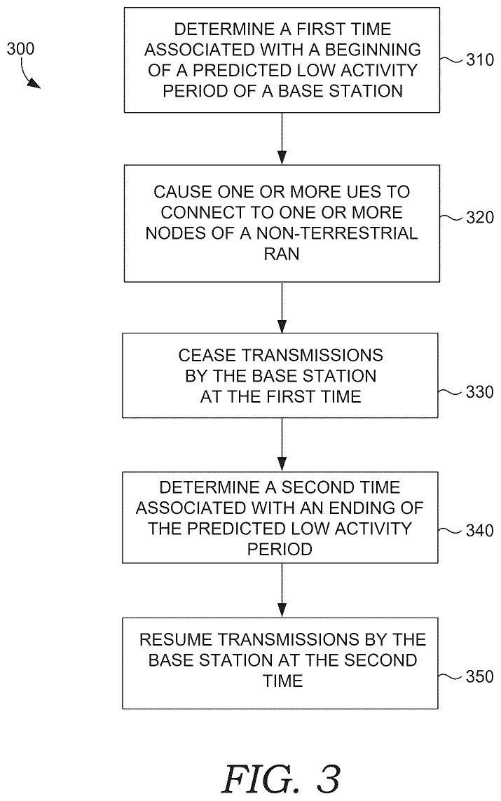

Turning now to FIG. 3, a flow chart representing a prospective method 300 for saving energy at a base station is provided. The prospective method 300 may be incorporated into a system having one or more of the components and/or features described with respect to FIG. 2. At a first step 310, one or more computer processing components may determine a first time associated with a beginning of a predicted low activity period of the base station, such as the terrestrial base station 230 of FIG. 2. In aspects, the one or more computer processing components determine the first time using one or more historical traffic parameters, as described with respect to FIG. 2. In a second step 320, the one or more computer processing components may cause one or more UEs, such as the UE 206 of FIG. 2, to connect to one or more nodes of a non-terrestrial radio access network (RAN), such as the non-terrestrial node 204 of the non-terrestrial network 208 of FIG. 2. The one or more nodes of the non-terrestrial RAN may be configured to wirelessly communicate with the one or more UEs in at least a portion of a first coverage area associated with the base station, such as the terrestrial coverage area 232. In a third step 330, the one or more computer processing components may cease transmissions by the base station at the first time, as described with respect to FIG. 2. In a fourth step 340, the one or more computer processing components may determine a second time associated with an ending of the predicted low activity period. In aspects, the second time is determined based on one or more historical traffic parameters, as described with respect to FIG. 2. In a fifth step 350, the one or more computer processing components resume transmissions by the base station at the second time, as described with respect to FIG. 2.

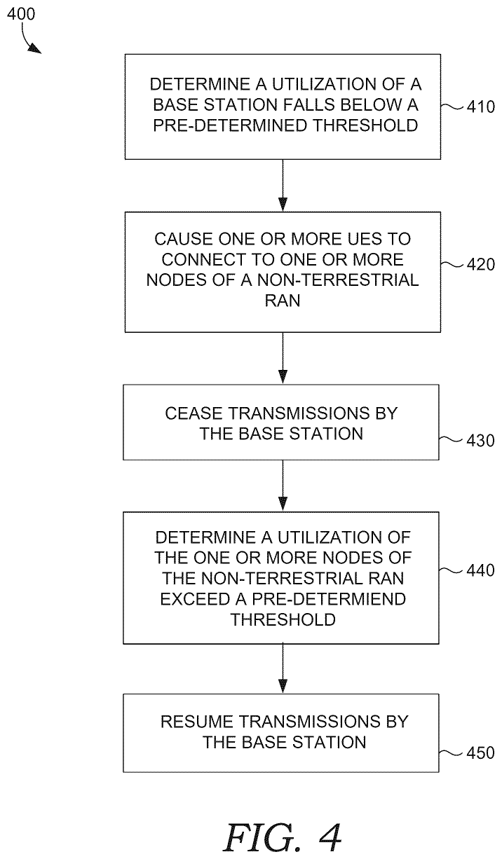

Turning now to FIG. 4, a flow chart representing a reactive method 400 for saving energy at a base station is provided. The reactive method 400 may be incorporated into a system having one or more of the components and/or features described with respect to FIGS. 2 and 3. At a first step 410, one or more computer processing components may determine a utilization of a base station, such as the terrestrial base station 230 of FIG. 2, falls below a pre-determined threshold, as described with respect to FIG. 2. At a second step 420, the one or more computer processing components may cause one or more UEs, such as the UE 206 of FIG. 2, to connect to one or more nodes of a non-terrestrial radio access network (RAN), such as the non-terrestrial node 204 of the non-terrestrial network 208 of FIG. 2. At a third step 430, the one or more computer processing components may cease transmissions by the base station at the first time, as described with respect to FIG. 2. At a fourth step 440, the one or more computer processing components may determine a utilization of the one or more nodes of the non-terrestrial RAN exceeds a pre-determined threshold, as described with respect to FIG. 2. At a fifth step 450, the one or more computer processing components may resume transmissions by the base station, as described with respect to FIG. 2.

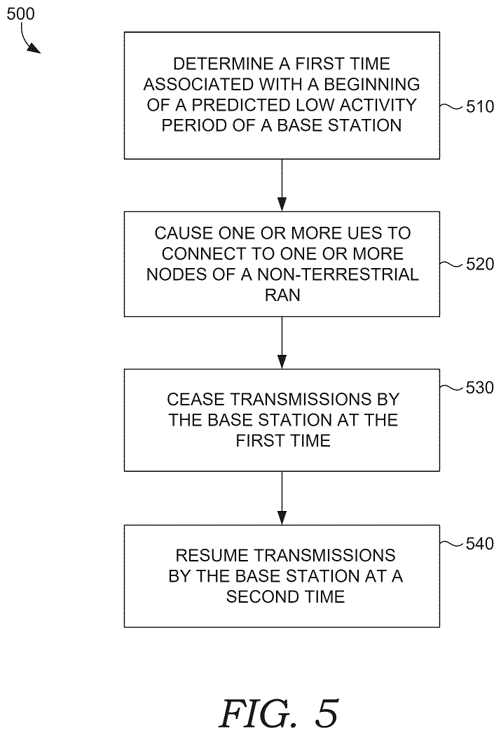

Turning now to FIG. 5, a flow chart representing a hybrid method 500 for saving energy at a base station is provided. The hybrid method 500 may be incorporated into a system having one or more of the components and/or features described with respect to FIGS. 2-4. At a first step 510, one or more computer processing components may determine a first time associated with a beginning of a predicted low activity period of the base station, such as the terrestrial base station 230 of FIG. 2. In aspects, one or more historical traffic parameters may assist in determining the first time, as described with respect to FIG. 2. At a second step 520, the one or more computer processing components may cause one or more UEs, such as the UE 206 of FIG. 2, to connect to one or more nodes of a non-terrestrial radio access network (RAN), such as the non-terrestrial node 204 of the non-terrestrial network 208 of FIG. 2. At a third step 530, the one or more computer processing components may cease transmissions by the base station at the first time, as described with respect to FIG. 2. At a fourth step 540, the one or more computer processing components may resume transmissions by the base station at a second time. In aspects, the second time may be associated with the earliest of an end of the predicted low activity period of the base station, as determined based on the one or more historical traffic parameters, or a time associated with a utilization of the one or more nodes of the non-terrestrial RAN exceeding a pre-determined threshold, as described with respect to FIG. 2.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for network energy saving, the system comprising:
a base station of a terrestrial RAN configured to wirelessly communicate with one or more user equipments (UEs) in a first coverage area; and
one or more computer processing components configured to perform operations comprising:
determining, based on one or more historical traffic parameters, a first time associated with a beginning of a predicted low activity period of the base station;
causing the one or more UEs to connect to one or more nodes of a non-terrestrial RAN, wherein the one or more nodes are configured to wirelessly communicate with the one or more UEs in at least a portion of the first coverage area;
ceasing transmissions by the base station at the first time; and
resuming transmissions by the base station at a second time, the second time associated with the earliest of:
an end of the predicted low activity period of the base station; or
a time associated with a utilization of the one or more nodes of the non-terrestrial RAN exceeding a pre-determined threshold.

2. The system of claim 1, wherein the utilization of the one or more nodes of the non-terrestrial RAN exceeds the pre-determined threshold when a number of active connections to the one or more nodes of the non-terrestrial RAN exceeds a pre-determined active connection threshold.

3. The system of claim 1, wherein the utilization of the one or more nodes of the non-terrestrial RAN exceeds the pre-determined threshold when a bandwidth of the one or more nodes of the non-terrestrial RAN exceeds a pre-determined bandwidth threshold.

4. The system of claim 1, wherein the utilization of the one or more nodes of the non-terrestrial RAN exceeds the pre-determined threshold when the measure of resource block utilization is 90% or greater of a total resource block capacity.

5. The system of claim 1, wherein the one or more historical traffic parameters comprise a predicted number of active connections to the base station at the first time.

6. The system of claim 1, wherein the end of the predicted low activity period of the base station comprises a time when a predicted number of active connections to the base station exceeds a pre-determined active connection threshold.

7. A system for network energy saving, the system comprising:
a base station of a terrestrial RAN configured to wirelessly communicate with one or more user equipments (UEs) in a first coverage area; and
one or more computer processing components configured to perform operations comprising:
determining, based on one or more historical traffic parameters, a first time associated with a beginning of a predicted low activity period of the base station;
causing the one or more UEs to connect to one or more nodes of a non-terrestrial RAN, wherein the one or more nodes are configured to wirelessly communicate with the one or more UEs in at least a portion of the first coverage area; and
ceasing transmissions by the base station at the first time.

8. The system of claim 7, wherein the operations further comprise:
determining, based on the one or more historical traffic patterns, a second time associated with an ending of the predicted low activity period of the base station; and
resuming transmissions by the base station at the second time.

9. The system of claim 8, wherein the one or more historical traffic parameters comprises a predicted number of active connections at the first time and at the second time.

10. The system of claim 9, wherein the first time occurs when the predicted number of active connections is predicted to fall below a pre-determined active connections threshold and the second time occurs when the number of active connections is predicted to exceed the pre-determined active connections threshold.

11. The system of claim 8, wherein the one or more historical traffic parameters comprises a predicted resource block utilization at the first time and at the second time.

12. The system of claim 11, wherein the first time occurs when the predicted resource block utilization is predicted to fall below a pre-determined resource block threshold and the second time occurs when the predicted resource block utilization is predicted to exceed the pre-determined resource block threshold.

13. The system of claim 7, wherein the operations further comprise:
determining a utilization of the one or more nodes of the non-terrestrial RAN exceeds a pre-determined non-terrestrial traffic threshold; and
resuming transmissions by the base station.

14. A system for network energy saving, the system comprising:
a base station of a terrestrial RAN configured to wirelessly communicate with one or more user equipments (UEs) in a first coverage area; and
one or more computer processing components configured to perform operations comprising:
determining a utilization of the base station falls below a pre-determined threshold; and
causing the one or more UEs to connect to one or more nodes of a non-terrestrial RAN, wherein the one or more nodes are configured to wirelessly communicate with the one or more UEs in at least a portion of the first coverage area; and
ceasing transmissions by the base station.

15. The system of claim 14, wherein the operations further comprise:
determining a utilization of the one or more nodes of the non-terrestrial RAN exceeds a pre-determined non-terrestrial traffic threshold;
resuming transmissions by the base station.

16. The system of claim 15, wherein the utilization of the one or more nodes of the non-terrestrial RAN exceeds the pre-determined non-terrestrial traffic threshold when a number of active connections to the one or more nodes of the non-terrestrial RAN exceeds a pre-determined active connection threshold.

17. The system of claim 14, wherein the utilization of the base station is a number of active connections to the base station.

18. The system of claim 17, wherein the utilization of the base station falls below the pre-determined threshold when the number of active connections to the base station is less than one active connection.

19. The system of claim 14, wherein the utilization of the base station is a resource block utilization of the base station.

20. The system of claim 19, wherein the utilization of the base station falls below the pre-determined threshold when the resource block utilization is 2% or less of a total resource block capacity.
